(19) United States
(12) Patent Application Publication
(10) Pub. No.: US 2026/0145697 A1
(43) Pub. Date: May 28, 2026

(54) IN-VEHICLE COCKPIT DRIVING STATE PROMPTING METHOD, COMPUTER-READABLE STORAGE MEDIUM AND ELECTRONIC DEVICE

(71) Applicant: XG TECH PTE. LTD., Singapore (SG)

(72) Inventors: Jingchang Huang, Singapore (SG); Ling ZHANG, Singapore (SG); Shuang WANG, Singapore (SG)

(21) Appl. No.: 19/203,577

(22) Filed: May 9, 2025

(30) Foreign Application Priority Data
Nov. 28, 2024 (CN) 2024117296533

(51) Int. Cl. B60W 50/14; B60W 40/09; G06V 20/59; G06V 40/16

(52) U.S. Cl. CPC B60W 50/14; B60W 40/09; G06V 20/597; G06V 40/171; B60W 2050/146; B60W 2420/403; B60W 2420/54; B60W 2540/01; B60W 2540/227; G06V 2201/07

(57) ABSTRACT

This disclosure relates to the technical field of intelligent cockpits, and discloses an in-vehicle cockpit driving state prompting method and system. The method includes: firstly obtaining feature information of an in-vehicle environment of a vehicle; determining, based on the feature information of the in-vehicle environment, feature information of a passenger in the vehicle, where the feature information includes at least one of gender and age; and in response to determining that the passenger belongs to a target object based on the feature information of the passenger, generating first prompt information for prompting the presence of the target object in the vehicle, so as to display the first prompt information by the vehicle. This solution does not require manual participation of a user, and has simpler implementations.

### RELATED APPLICATION INFORMATION

This disclosure claims priority to and the benefit of Chinese patent application Ser. No. 2024117296533 filed on Nov. 28, 2024, which is incorporated herein by reference in its entirety.

### FIELD OF THIS DISCLOSURE

This disclosure relates to the technical field of intelligent cockpits, and more particularly relates to an in-vehicle cockpit driving state prompting method, apparatus and system.

### BACKGROUND OF THIS DISCLOSURE

In a traveling process of a vehicle, a cockpit of the vehicle is a closed space in high-speed running, so that for a by-pass vehicle, a cockpit driving state of the vehicle is a black box. However, the cockpit driving state often plays an important role in traveling safety. For example, if an infant is in the vehicle, or a driver is a novice driver, a driver of the by-pass vehicle generally gives way to the vehicle after knowing this cockpit driving state, so as to improve the traveling safety of the vehicle.

In order to enable the by-pass vehicle to know the cockpit driving state, it is currently common for a user of the vehicle to purchase a sticker and manually affix the sticker to the vehicle, and the sticker includes characters (such as “Baby in Car”, “Baby in Vehicle, Please Give Us Your Support and Consideration”, or “I Am a Novice, Please Give Me Your Support and Consideration”) for indicating the cockpit driving state.

However, an embodiment of the solution is relatively cumbersome, and if the cockpit driving state changes, the sticker cannot reflect the change in time, that is, the timeliness of the solution is relatively poor.

### SUMMARY OF THIS DISCLOSURE

In order to solve the above technical problem, this disclosure provides an in-vehicle cockpit driving state prompting method, apparatus and system for simply and conveniently prompting an in-vehicle cockpit driving state and improving the timeliness of prompting the in-vehicle cockpit driving state.

According to a first aspect of this disclosure, an in-vehicle cockpit driving state prompting method is provided, including:
obtaining feature information of an in-vehicle environment of a vehicle;
determining, based on the feature information of the in-vehicle environment, feature information of a passenger in the vehicle; and
in response to determining that the passenger belongs to a target object based on the feature information of the passenger, generating first prompt information for prompting the presence of the target object in the vehicle, so as to display the first prompt information by the vehicle.

According to a second aspect of this disclosure, an in-vehicle cockpit driving state prompting apparatus is provided, including:
a first information obtaining module configured for obtaining feature information of an in-vehicle environment of a vehicle;
a first information determination module configured for determining, based on the feature information of the in-vehicle environment obtained by the first information obtaining module, feature information of a passenger in the vehicle; and
a first information generation module configured for, in response to determining that the passenger belongs to a target object based on the feature information of the passenger determined by the first information determination module, generating first prompt information for prompting the presence of the target object in the vehicle, so as to display the first prompt information by the vehicle.

According to a third aspect of this disclosure, a computer-readable storage medium is provided, wherein the storage medium stores a computer program for executing the in-vehicle cockpit driving state prompting method according to the above first aspect.

According to a fourth aspect of this disclosure, an electronic device is provided, including:
a second processor; and
a memory configured for storing processor-executable instructions;
wherein the second processor is configured for reading the executable instructions from the memory and executing the instructions to implement the in-vehicle cockpit driving state prompting method according to the above first aspect.

According to a fifth aspect of this disclosure, a computer program product is provided, wherein, when instructions in the computer program product are executed by a processor, the in-vehicle cockpit driving state prompting method according to the first aspect of this disclosure is executed.

In the in-vehicle cockpit driving state prompting method, the feature information of the in-vehicle environment of the vehicle is firstly obtained; the feature information of the passenger in the vehicle is determined based on the feature information of the in-vehicle environment; and in response to that the passenger belongs to the target object is determined based on the feature information of the passenger, the first prompt information for prompting the presence of the target object in the vehicle is generated, so as to display the first prompt information by the vehicle. In the solution of this disclosure, by collecting the feature information of the in-vehicle environment in real time, the first prompt information is automatically generated and displayed, allowing other vehicles around the vehicle to know the cockpit driving state of the presence of the target object in the vehicle, which is beneficial to avoiding traffic accidents between the other vehicles and the vehicle, thereby improving the traveling safety.

### BRIEF DESCRIPTION OF THE DRAWINGS

FIG. 1 is a schematic diagram of architecture of a vehicle to which this disclosure is applicable.

FIG. 2 is a schematic flowchart of an in-vehicle cockpit driving state prompting method provided by an exemplary embodiment of this disclosure.

FIG. 3 is a schematic flowchart of the in-vehicle cockpit driving state prompting method provided by another exemplary embodiment of this disclosure.

FIG. 4 is a schematic flowchart of the in-vehicle cockpit driving state prompting method provided by another exemplary embodiment of this disclosure.

FIG. 5 is a schematic flowchart of the in-vehicle cockpit driving state prompting method provided by another exemplary embodiment of this disclosure.

FIG. 6 is a schematic flowchart of the in-vehicle cockpit driving state prompting method provided by another exemplary embodiment of this disclosure.

FIG. 7 is a schematic flowchart of the in-vehicle cockpit driving state prompting method provided by another exemplary embodiment of this disclosure.

FIG. 8 is a schematic flowchart of the in-vehicle cockpit driving state prompting method provided by another exemplary embodiment of this disclosure.

FIG. 9 is a schematic flowchart of the in-vehicle cockpit driving state prompting method provided by another exemplary embodiment of this disclosure.

FIG. 10 is a schematic diagram of a structure of an in-vehicle cockpit driving state prompting apparatus provided by an exemplary embodiment of this disclosure.

FIG. 11 is a schematic diagram of a structure of the in-vehicle cockpit driving state prompting apparatus provided by another exemplary embodiment of this disclosure.

FIG. 12 is a schematic diagram of a structure of the in-vehicle cockpit driving state prompting apparatus provided by another exemplary embodiment of this disclosure.

FIG. 13 is a schematic diagram of a structure of an electronic device provided by an exemplary embodiment of this disclosure.

### DESCRIPTION OF THE EMBODIMENTS

To explain this disclosure, exemplary embodiments of this disclosure are described below in detail with reference to accompanying drawings. Obviously, the embodiments described are merely some, rather than all of embodiments of this disclosure. It should be understood that this disclosure is not limited by the exemplary embodiments.

It should be noted that unless otherwise specified, the scope of this disclosure is not limited by relative arrangement, numeric expressions, and numerical values of components and steps described in these embodiments.

### Application Overview

In a traveling process of a vehicle, a cockpit of the vehicle is a closed space, so that neither a passenger nor a driver of a by-pass vehicle can know a cockpit driving state of the vehicle, and for the passenger and the driver of the by-pass vehicle, the cockpit driving state is a black box.

The cockpit driving state of the vehicle this disclosure may include various types of information, for example, the cockpit driving state may indicate whether passengers in the vehicle include an infant or a pregnant woman, and the like, or whether the driver of the vehicle is an inexperienced novice driver or a more experienced senior driver, and the like.

The cockpit driving state of the vehicle often plays an important role in a process of traveling safety. For example, if an infant is in the vehicle, the driver of the by-pass vehicle generally gives way to the vehicle after knowing this cockpit driving state, so as to provide the infant with comfortable riding feeling, thereby improving the traveling smoothness of the vehicle; or if the driver of the vehicle is a novice driver, the driver of the by-pass vehicle generally also gives way to the vehicle after knowing this cockpit driving state, so as to avoid collision or scratching with the vehicle, thereby improving the traveling safety of the vehicle.

In order to enable the by-pass vehicle to know the cockpit driving state, it is currently common for a user of the vehicle to purchase a sticker for indicating the cockpit driving state and manually affix the sticker outside the vehicle. The sticker includes characters for indicating the cockpit driving state. For example, if an infant is in the vehicle, the affixed sticker generally includes characters such as “Baby in Car”, or “Baby in Vehicle, Please Give Us Your Support and Consideration”; and if a driver of the vehicle is a novice driver, the sticker may include characters such as “I Am a Novice, Please Give Me Your Support and Consideration”.

However, this solution requires the user of the vehicle to purchase and affix the sticker, and therefore, an implementation process is relatively cumbersome.

In addition, if the cockpit driving state of the vehicle changes, the sticker cannot reflect the change in time, so that the timeliness is relatively poor.

For example, if the temporarily additional passenger in the vehicle is a pregnant woman or an infant, reminders such as the sticker “Baby in Car” cannot be added in time, and the surrounding vehicles cannot be reminded of the cockpit driving state in the vehicle in real time, thereby reducing the timeliness of the cockpit driving state.

In order to solve the problems of a cumbersome implementation process and poor timeliness in the prior art in which the cockpit driving state is prompted by the sticker, this disclosure provides an in-vehicle cockpit driving state prompting method, apparatus and corresponding system. In the solution of this disclosure, first prompt information is automatically generated by feature information of an in-vehicle environment of a vehicle and displayed, allowing other vehicles around the vehicle to know a cockpit driving state of the presence of a target object in the vehicle, which is beneficial to avoiding traffic accidents between the other vehicles and the vehicle, thereby improving the traveling safety.

### Exemplary System

Embodiments of this disclosure provide an in-vehicle cockpit driving state prompting method, apparatus and corresponding system to achieve the prompting of an in-vehicle cockpit driving state.

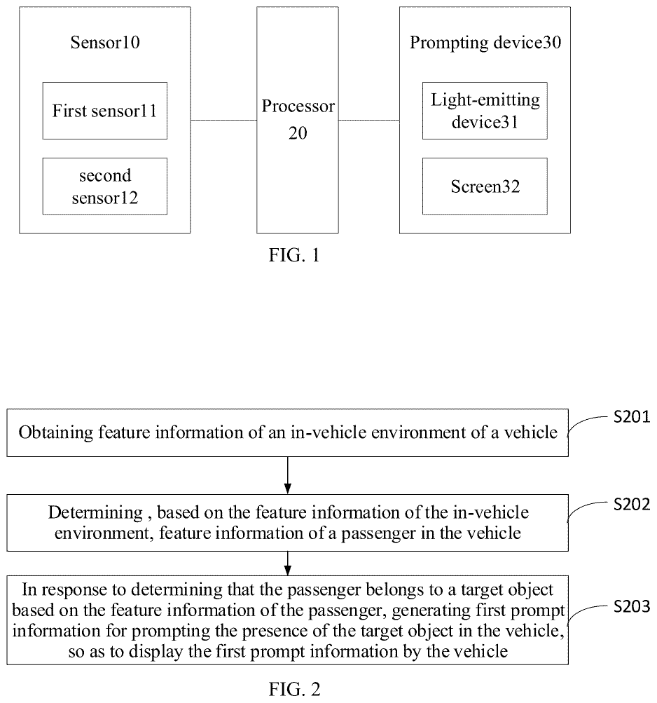

In one possible implementation, the method provided by the embodiment of this disclosure may be applied by a vehicle. Referring to a schematic diagram of architecture of the vehicle shown in FIG. 1, the vehicle may include a sensor 10, a first processor 20 and a prompting device 30.

The sensor 10 may include a first sensor 11 configured for collecting feature information of an in-vehicle environment of the vehicle.

Generally, the first sensor 11 includes an image collection apparatus and/or an audio collection apparatus disposed in a cockpit. The image collection apparatus may include an in-cockpit camera and the like, wherein the in-cockpit camera is used for photographing an interior of the vehicle to collect an image of the in-vehicle environment. Exemplarily, in an intelligent cockpit, a driver monitoring system (DMS) is generally disposed, and the DMS includes a camera which may serve as the first sensor 11 this disclosure; in addition, the intelligent cockpit may also be provided with an occupancy monitoring system (OMS), and the OMS also includes a camera which may also serve as the first sensor 11 this disclosure.

In addition, the audio collection apparatus may include a microphone array and the like for collecting audio information of the in-vehicle environment. Accordingly, the feature information of the in-vehicle environment may include the image of the in-vehicle environment and/or the audio information of the in-vehicle environment.

The first processor 20 may obtain feature information of an in-vehicle environment of a vehicle collected by the sensor 10. After obtaining the feature information of the in-vehicle environment, the first processor 20 determines, based on the feature information of the in-vehicle environment of the vehicle, feature information of a passenger in the vehicle; then in response to determining that the passenger belongs to a target object based on the feature information of the passenger, generates first prompt information for prompting the presence of the target object in the vehicle.

The prompting device 30 may obtain the first prompt information generated by the first processor 20 and display the first prompt information to function as a prompt.

In one possible implementation, the prompting device 30 may include light-emitting devices 31 disposed outside the vehicle, and generally a plurality of light-emitting devices are included. In this case, the first prompt information may be used for indicating switch states of light-emitting devices. After receiving the first prompt information, each of the light-emitting devices enters an on or off state according to target switch states indicated by the first prompt information, so that the prompting device 30 displays a target lighting effect for prompting the presence of the target object in the vehicle, so as to function as a prompt of an in-vehicle cockpit driving state.

Or, in another possible implementation, the prompting device 30 may include a screen 32 disposed outside the vehicle. In this case, the first prompt information may be used for causing the screen to display a prompt picture. After receiving the first prompt information, the screen outside the vehicle may display a corresponding prompt picture for prompting the presence of the target object in the vehicle, so as to function as a prompt of the in-vehicle cockpit driving state.

Of course, the prompting device 30 may also include the light-emitting device 31 and the screen 32 disposed outside the vehicle simultaneously, which is not limited this disclosure.

By means of the solution provided by the embodiment of this disclosure, the cockpit driving state of the presence of the target object in the vehicle can be prompted by the first prompt information.

Further, the first processor 20 may also perform information interaction with a bus of the vehicle, and the bus may include a CAN bus, and the like. Or, the first processor 20 may perform information interaction with a braking device and a traveling device (such as a tire) of the vehicle. The first processor 20 may obtain driving behavior information of a driver through the information interaction with the bus, or with the braking device and the traveling device.

The first processor 20 may, in response to determine a driving state of the driver in a first driving scenario based on the driving behavior information, generate second prompt information for prompting that the driver is in a target driving state in the case that the driving state of the driver is the target driving state, so as to display the second prompt information by the vehicle, wherein the second prompt information may also be displayed by the prompting device 30.

The first processor 20 may determine whether the driving state of the driver is the target driving state in a plurality of modes. In one possible implementation, the first processor 20 may determine whether the driving state of the driver is the target driving state based only on the driving behavior information.

In another possible implementation, the sensor 10 may also include a second sensor 12, and the second sensor 12 is used for collecting feature information of an out-of-vehicle environment of the vehicle. The second sensor 12 may include at least one of an image collection apparatus (such as an out-of-cockpit camera for photographing the out-of-vehicle environment of the vehicle), radar (such as lidar) and an ultrasonic sensor which are disposed outside the cockpit. Moreover, after collecting the feature information of the out-of-vehicle environment, the second sensor 12 may transmit the feature information of the out-of-vehicle environment to the first processor 20.

In addition, the first processor 20 may run an autonomous driving engine, in a traveling process of the vehicle, after the first processor 20 obtains the feature information of the out-of-vehicle environment transmitted by the second sensor 12, the autonomous driving engine may determine a corresponding driving instruction according to the feature information of the out-of-vehicle environment. In a first driving scenario, the first processor 20 may determine whether the driving state of the driver is the target driving state based on the driving behavior information and the driving instruction.

By means of this solution, the cockpit driving state in which the driver is in the target driving state can be prompted by the second prompt information.

### Exemplary Method

FIG. 2 is a schematic flowchart of an in-vehicle cockpit driving state prompting method provided by an exemplary embodiment of this disclosure. This embodiment may be applied to an electronic device, and the electronic device may include a vehicle-mounted chip, and the like. As shown in FIG. 2, the method includes the following steps.

Step 201: Obtaining feature information of an in-vehicle environment of a vehicle.

In one possible embodiment of this disclosure, electronic device for executing an embodiment of this disclosure may perform information interaction with a first sensor, and obtain feature information collected by the first sensor.

The first sensor may include an image collection apparatus and/or an audio collection apparatus. The image collection apparatus may include an in-cockpit camera and the like for collecting an image of the in-vehicle environment. After collecting the image of the in-vehicle environment, the image collection apparatus may transmit the image to the electronic device, so that the electronic device obtains the image. Accordingly, the feature information of the in-vehicle environment of the vehicle includes the image of the in-vehicle environment.

Of course, the image collection apparatus may further include other apparatuses capable of collecting the image of the in-vehicle environment, which is not limited this disclosure.

In addition, the audio collection apparatus may include a microphone array and the like for collecting audio information of the in-vehicle environment, and after collecting the audio information of the in-vehicle environment, the audio collection apparatus may transmit the audio information to the electronic device, so that the electronic device obtains the audio information. Accordingly, the feature information of the in-vehicle environment of the vehicle includes the audio information of the in-vehicle environment.

Of course, the audio collection apparatus may further include other apparatuses capable of collecting the audio information of the in-vehicle environment, which is not limited this disclosure.

In addition, the first sensor may include the image collection apparatus and the audio collection apparatus simultaneously, and the feature information of the in-vehicle environment of the vehicle may include both the image and the audio information of the in-vehicle environment.

Step 202: Determining, based on the feature information of the in-vehicle environment, feature information of a passenger in the vehicle.

The feature information may include at least one of gender, age and posture information.

Step 203: In response to determining that the passenger belongs to a target object based on the feature information of the passenger, generating first prompt information for prompting the presence of the target object in the vehicle, so as to display the first prompt information by the vehicle.

The target object may include a pregnant woman and/or an infant. Of course, the target object may also include other types of objects, which is not limited this disclosure.

The embodiment of this disclosure provides the in-vehicle cockpit driving state prompting method. In the method, the feature information of the in-vehicle environment of the vehicle is firstly obtained; the feature information of the passenger in the vehicle is determined based on the feature information of the in-vehicle environment; and in response to that the passenger belongs to the target object is determined based on the feature information of the passenger, the first prompt information for prompting the presence of the target object in the vehicle is generated, so as to display the first prompt information by the vehicle.

The solution of the embodiment of this disclosure can prompt the cockpit driving state of the presence of the target object in the vehicle by the first prompt information. Moreover, the solution does not require manual participation of a user, thereby having the advantage of a simple and convenient implementation. Further, moreover, since the first prompt information is generated according to the feature information of the in-vehicle environment of the vehicle, if the feature information of the in-vehicle environment of the vehicle changes, the solution generates the first prompt information based on the changed feature information. Therefore the first prompt information can reflect the change in the in-vehicle cockpit driving state. Accordingly, the solution of the embodiment of this disclosure also has the advantage of better timeliness.

In the solution of this disclosure, by collecting the feature information of the in-vehicle environment in real time, the first prompt information is automatically generated and displayed, allowing other vehicles around the vehicle to know the cockpit driving state of the presence of the target object in the vehicle, which is beneficial to avoiding traffic accidents between the other vehicles and the vehicle, thereby improving the traveling safety.

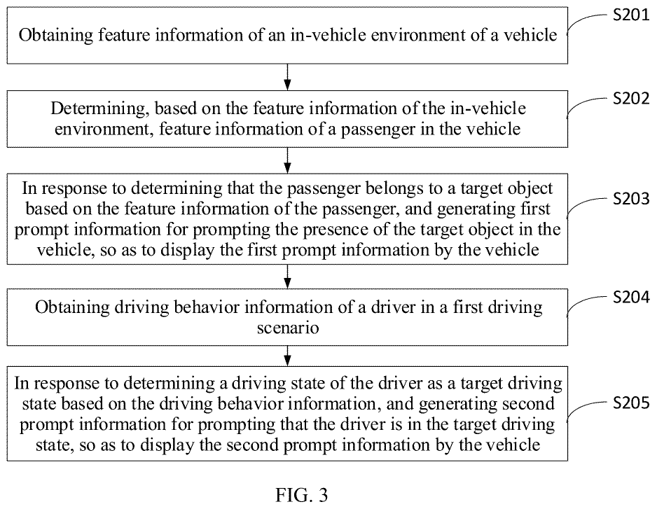

The driver of the vehicle may be a novice driver or a senior driver with richer driving experience, and driving states of different drivers are different. For this case, in another embodiment of this disclosure, referring to a schematic working flowchart shown in FIG. 3, the method further includes the following steps on the basis of the embodiment shown in FIG. 2.

Step 204: Obtaining driving behavior information of a driver in a first driving scenario.

The driving scenario includes an autonomous driving scenario and a manual driving scenario. In the autonomous driving scenario, an electronic device (such as a vehicle-mounted chip) may run an autonomous driving engine, and the autonomous driving engine may generate a corresponding driving instruction based on feature information of an out-of-vehicle environment of the vehicle to instruct the vehicle to execute corresponding operation by the driving instruction. In the manual driving scenario, the vehicle executes corresponding operation according to the received behavior information of the driver.

In the embodiment of this disclosure, the first driving scenario may be the manual driving scenario. The driving behavior information is used for indicating a behavior of operating the vehicle by the driver, such as accelerating, decelerating or turning the vehicle, and the like.

Information of various devices (such as an engine, a braking system, a steering system and a chassis) in the vehicle may be transmitted to a first processor of the vehicle through a bus (such as a CAN bus) of the vehicle, so that the first processor may control the vehicle according to the received information. Therefore, the bus of the vehicle may transmit state information of the devices in the vehicle to the first processor of the vehicle, such as a rotational speed of the engine, braking pressure, a steering angle of a steering wheel, and throttle pressure.

In one possible embodiment of the embodiment of this disclosure, the electronic device may obtain the state information of the devices in the vehicle transmitted by the bus through information interaction with the bus, and further determine the driving behavior information of the driver based on the state information.

In another possible implementation, the electronic device may be connected to the devices in the vehicle to obtain the state information of the devices and then determine the driving behavior information of the driver based on the obtained state information of the devices.

Of course, in the embodiment of this disclosure, the driving behavior information of the driver in the first driving scenario may also be obtained in other modes, which is not limited this disclosure.

Step 205: In response to determining a driving state of the driver being a target driving state based on the driving behavior information, generating second prompt information for prompting that the driver is in the target driving state, so as to display the second prompt information by the vehicle.

In one possible embodiment of this disclosure, the target driving state is a novice driving state, and the second prompt information is information for prompting that the driver is in the novice driving state. In other words, in this implementation, in the case that the driving state of the driver is determined as the novice driving state, the second prompt information is used for prompting.

This disclosure, whether the driving state of the driver is the target driving state is determined based on the driving behavior information of the driver in the first driving scenario. When the driving state of the driver changes, the driving behavior information of the driver also changes. The change in the driving state of the driver is determined in time based on the changed driving behavior information, and the second prompt information may be regenerated in the case of the change. Therefore, the solution of the embodiment of this disclosure has better timeliness. Moreover, the solution does not require manual participation of the user, so that the embodiment is simple and convenient.

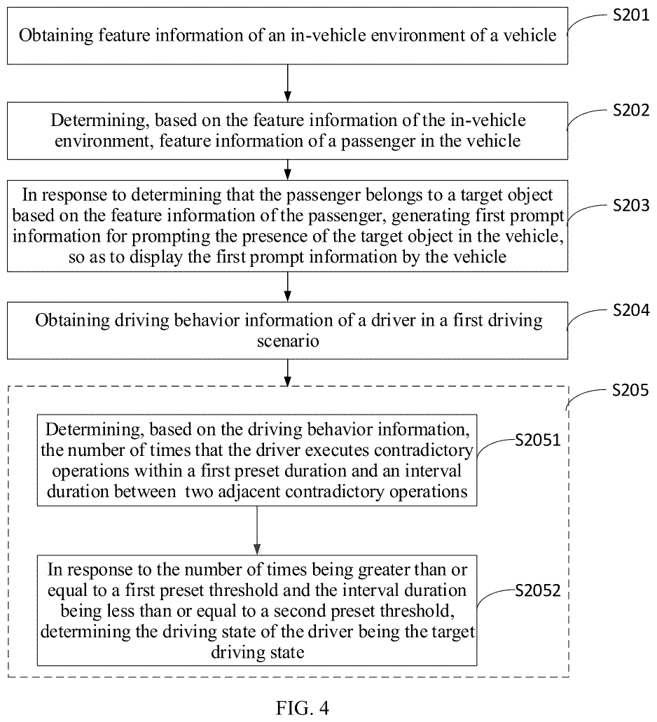

As shown in FIG. 4, step 205 may include the following steps.

Step 2051: Determining, based on the driving behavior information, the number of times that the driver executes contradictory operations within a first preset duration and an interval duration between two adjacent contradictory operations.

The driving behavior information may reflect the operation executed by the driver. Exemplarily, the operation may include: accelerating operation, decelerating operation, braking operation, straight-line operation, left-turn operation, right-turn operation, and the like, which is not limited this disclosure.

Exemplarily, the contradictory operations of the accelerating operation may include the decelerating operation and the braking operation, the contradictory operations of the decelerating operation may include the accelerating operation, the contradictory operations of the braking operation may include the accelerating operation, the contradictory operations of the straight-line operation may include the left-turn operation and the right-turn operation, the contradictory operations of the left-turn operation may include the straight-line operation and the right-turn operation, while the contradictory operations of the right-turn operation may include the straight-line operation and the left-turn operation.

In this step, an obtaining moment of the driving behavior information may be taken as a moment when the driver performs the operation indicated by the driving behavior information. In one possible embodiment of the embodiment of this disclosure, operations executed by the driver may be determined based on the driving behavior information, and in the case that it is determined that the contradictory operations are executed, the interval duration between two adjacent contradictory operations are determined based on the obtaining moment of the driving behavior information corresponding to the contradictory operation.

Step 2052: In response to the number of times being greater than or equal to a first preset threshold and the interval duration being less than or equal to a second preset threshold, determining the driving state of the driver being the target driving state.

In this step, the target driving state is the novice driving state.

In the embodiment of this disclosure, the first preset duration is generally a relatively short duration, such as one minute. If the number of times the driver executes the contradictory operations within the first preset duration is greater than or equal to the first preset threshold, and the interval duration between two adjacent the contradictory operations by the driver is less than or equal to the second preset threshold, it suggests that the driver frequently performs contradictory driving operations within the first preset duration, and the driver is unfamiliar with the driving operations of the vehicle and often flustered, so that the driver is very likely a novice. Accordingly, it may be determined that the driver is in the novice driving state.

The solution of the embodiment of this disclosure can determine the number of times that the driver executes the contradictory operations within the first preset duration and the interval duration based on the driving behavior information, and determine whether the driving state of the driver is the target driving state based on a comparison between the number of times and the first preset threshold and a comparison between the interval duration between two adjacent contradictory operations by the driver and the second preset threshold.

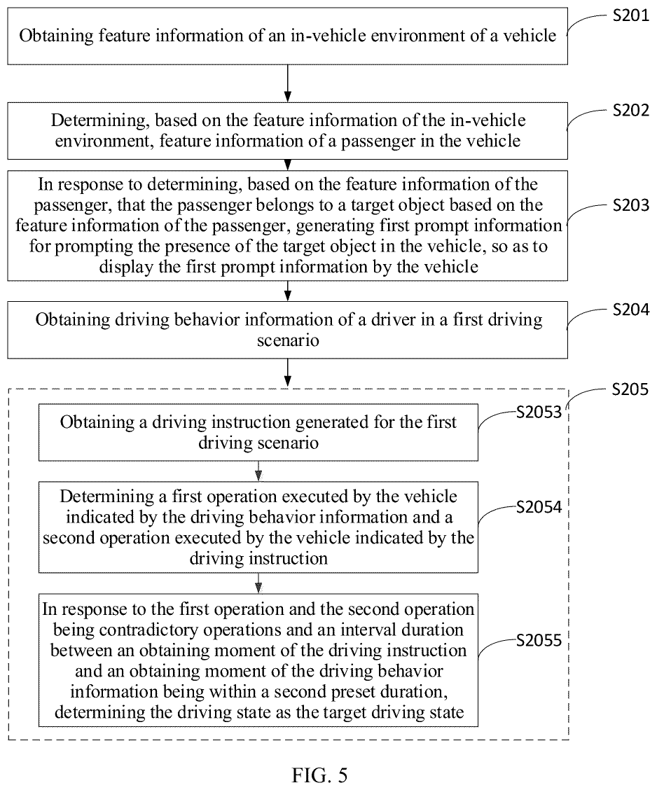

In another embodiment, as shown in FIG. 5, step 205 may include the following steps.

Step 2053: Obtaining a driving instruction generated for the first driving scenario.

In the embodiment of this disclosure, the vehicle may support an autonomous driving scenario and a manual driving scenario. In the autonomous driving scenario, the electronic device may run an autonomous driving engine, and the autonomous driving engine may generate a corresponding driving instruction based on feature information of an out-of-vehicle environment of the vehicle to instruct the vehicle to execute corresponding operation by the driving instruction. In the manual driving scenario, the vehicle executes corresponding operation according to the received behavior information of the driver.

In this step, the first driving scenario may be the manual driving scenario, and in the first driving scenario, the electronic device (such as a vehicle-mounted chip) may still run the autonomous driving engine, so that the electronic device obtains the driving instruction generated by the autonomous driving engine.

Step 2054: Determining a first operation executed by the vehicle indicated by the driving behavior information and a second operation executed by the vehicle indicated by the driving instruction.

Step 2055: Determining the driving state being the target driving state in response to the first operation and the second operation being contradictory operations and an interval duration between an obtaining moment of the driving instruction and an obtaining moment of the driving behavior information being within a second preset duration.

In this step, the target driving state is the novice driving state.

The second preset duration is generally a relatively short duration, such as one minute. If the time interval between the obtaining moment of the driving instruction and the obtaining moment of the driving behavior information is within the second preset duration, it indicates the obtaining moment of the driving instruction is relatively close to the obtaining moment of the driving behavior information. If the first operation and the second operation are contradictory operations, it indicates the driver executes a driving operation contradictory to the driving instruction in a short time, which means that the driver is unfamiliar with the driving operation of the vehicle. The possibility that the driver is a novice is high. Accordingly, it may be determined that the driver is in the novice driving state.

The solution of the embodiment of this disclosure may determine the first operation indicated by the driving behavior information and the second operation indicated by the driving instruction generated for the first driving scenario, and determine the driving state of the driver being the target driving state in the case that the first operation and the second operation are the contradictory operations and the time interval between the obtaining moment of the driving instruction and the obtaining moment of the driving behavior information is within the second preset duration, so that whether the driver is in the target driving state is determined based on the driving instruction generated for the first driving scenario and the driving behavior information.

In another embodiment, the feature information of the passenger includes at least one of gender, age and posture information. Step 203 may include the following steps on the basis of the above embodiment shown in FIG. 2.

That the gender corresponding to the passenger is female is determined based on the gender in the feature information of the passenger, that the passenger is a pregnant woman is determined based on the posture information in the feature information of the passenger, and then first sub-prompt information for prompting the presence of the pregnant woman in the vehicle is generated.

In the embodiment of this disclosure, the feature information of the passenger includes the gender and the posture information of the passenger. In the embodiment of this disclosure, after determining that the passenger is female, it may be further determined that whether the posture information of the passenger conforms to posture information of the pregnant woman, and if so, it may be determined that the passenger is the pregnant woman.

Exemplarily, some pregnant women may have bulges in their abdomens, or some pregnant women may have edema in their faces, which may serve as the posture information conforming to the pregnant women. If a certain passenger is female, and the passenger has a bulge in her abdomen, or the passenger has edema in her face, it may be determined that the passenger is the pregnant woman.

Of course, in the embodiment of this disclosure, whether the female passenger is the pregnant woman may also be determined by other posture information, which is not limited this disclosure.

In addition, step 203 may include the following steps.

That the passenger is an infant is determined based on the age in the feature information of the passenger, and then second sub-prompt information for prompting the presence of the infant in the vehicle is generated.

The solution of the embodiment of this disclosure may determine whether the passenger is the pregnant woman based on the gender and the posture information in the feature information of the passenger, and generate the first sub-prompt information in the case that it is determined that the passenger is the pregnant woman; moreover, it may be determined whether the passenger is the infant based on the age in the feature information of the passenger, and the second sub-prompt information is generated in the case that it is determined that the passenger is the infant. Therefore, by means of the solution of the embodiment of this disclosure, the corresponding first prompt information may be used for prompting in the case that the passengers in the vehicle include the pregnant woman or the infant.

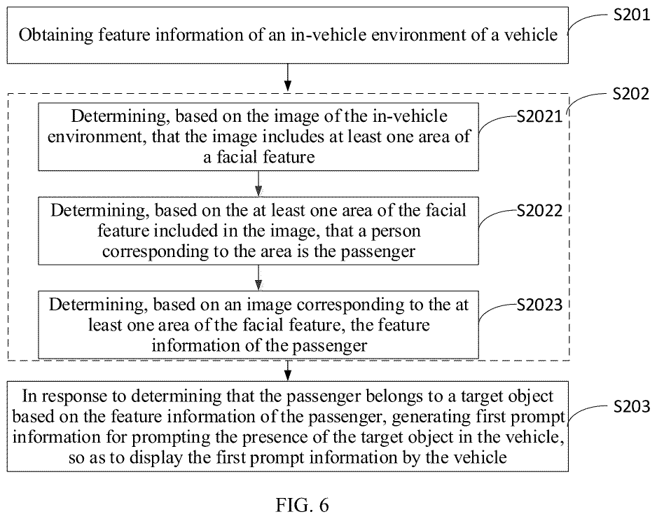

As shown in FIG. 6, the feature information of the in-vehicle environment includes an image of the in-vehicle environment, and step 202 may include the following steps on the basis of the above embodiment shown in FIG. 2.

Step 2021: Determining, based on the image of the in-vehicle environment, that the image includes at least one area of a facial feature.

In this step, face detection may be performed on the image of the in-vehicle environment by a face detection technology, it is determined that the image includes at least one area of the facial feature based on a result of the face detection, and a position of the area may be represented by coordinates of the area in the image, wherein the facial feature may include at least one of five sense organs of a face, eyebrows and hair.

Exemplarily, in this step, the face detection may be achieved by a machine learning method, and of course, the face detection may also be achieved in other modes, which is not limited this disclosure.

Step 2022: Determining, based on the at least one area of the facial feature included in the image, that a person corresponding to the area is the passenger.

The driver and the passenger are generally included in the vehicle, and in this step, whether the person corresponding to the area is the passenger may be determined according to a photographing angle of a camera for photographing the image and the area of the facial feature included in the image to distinguish the driver and the passenger respectively corresponding to the area of the facial feature included in the image, wherein the person located at a non-driving position is the passenger.

Step 2023: Determining, based on an image corresponding to the at least one area of the facial feature, the feature information of the passenger.

In this step, face attribute analysis may be performed on a face of the passenger included in the image by a face attribute analysis technology, and the feature information of the passenger may be determined based on a result of the analysis.

Exemplarily, in this step, the face attribute analysis may be achieved by a machine learning method, and of course, the face attribute analysis may also be achieved in other modes, which is not limited this disclosure.

The feature information of the passenger may include at least one of gender, age and posture information.

By means of the solution of this embodiment, the feature information of the passenger in the vehicle may be determined according to the image of the in-vehicle environment.

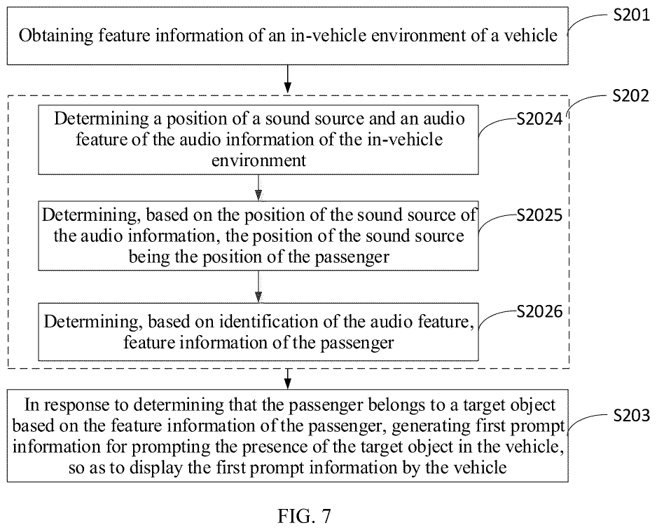

In one possible implementation, the feature information of the in-vehicle environment includes audio information of the in-vehicle environment. As shown in FIG. 7, step 202 may include the following steps on the basis of the above embodiment shown in FIG. 2.

Step 2024: Determining a position of a sound source and an audio feature of the audio information of the in-vehicle environment.

Exemplarily, in the embodiment of this disclosure, the audio information of the in-vehicle environment is collected by a microphone array. The microphone array consists of a plurality of microphones, which are distributed at different positions. When the sound source sends the audio information, moments when the audio information arrives at different microphones are often different. Therefore the position of the sound source may be determined based on time differences of the moments when the audio information arrives at the different microphones and the positions at which the microphones are distributed.

In addition, the audio feature is a feature of audio information sent for distinguishing passengers of different genders and/or different ages. Exemplarily, the audio feature may include at least one of a Mel-frequency cepstral coefficient, a pitch frequency and a tone frequency. Of course, the audio feature may further include other features, which is not limited this disclosure.

Step 2025: Determining, based on the position of the sound source of the audio information, the position of the sound source being the position of the passenger.

In this step, if the position of the sound source of the audio information is a non-driving position, the position of the sound source is determined as the position of the passenger.

Step 2026: Determining, based on identification of the audio feature, feature information of the passenger.

In this step, the audio feature may be identified by a sound detection model, and the feature information of the passenger may be determined based on a result of the identification.

The sound detection model may be constructed by a machine learning method, and of course, the sound detection model may also be constructed in other modes, which is not limited this disclosure.

By means of the solution of this embodiment, the feature information of the passenger in the vehicle may be determined according to the audio information of the in-vehicle environment.

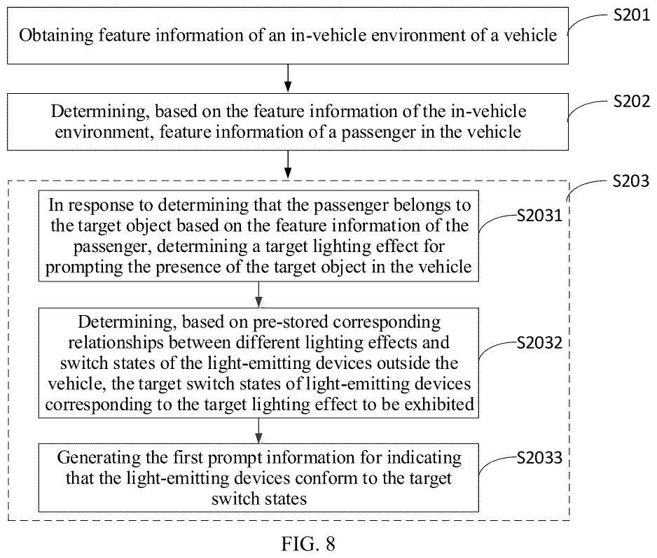

As shown in FIG. 8, step 203 may include the following steps on the basis of the above embodiment shown in FIG. 2.

Step 2031: In response to determining that the passenger belongs to the target object based on the feature information of the passenger, determining a target lighting effect for prompting the presence of the target object in the vehicle.

In the embodiment of this disclosure, corresponding relationships between passengers belonging to different target objects and different lighting effects may be pre-stored. The target lighting effect may be determined based on the corresponding relationship after determining that the passenger belongs to the target object.

The target lighting effect may be characters or patterns for prompting the presence of the target object in the vehicle. Exemplarily, if the target object is the pregnant woman, the target lighting effect may include the characters “Pregnant Woman in Vehicle, Please Give Us Your Support and Consideration”, or may also include a pattern of a stick figure of the pregnant woman; and if the target object is the infant, the target lighting effect may include the characters such as “Baby in Car”, or “Baby in Vehicle, Please Give Us Your Support and Consideration”, or may also include a pattern of a stick figure of the infant.

Of course, the target lighting effect may also be lighting effects in other forms, which is not limited this disclosure.

Step 2032: Determining, based on pre-stored corresponding relationships between different lighting effects and switch states of the light-emitting devices outside the vehicle, the target switch states of the light-emitting devices corresponding to target lighting effects to be exhibited.

A plurality of light-emitting devices are disposed outside the vehicle, and exemplarily, the light-emitting device may include a plurality of rows of light-emitting diodes disposed side by side. By turning on part of the plurality of light-emitting devices and turning off the other part of the plurality of light-emitting devices, the plurality of light-emitting devices may exhibit different lighting effects, wherein the switch states of the light-emitting devices are used for indicating whether the light-emitting devices are in a turning-on and lighting state or in a turning-off state.

In the embodiment of this disclosure, the corresponding relationships between the different lighting effects and the switch states of the light-emitting devices outside the vehicle may be pre-stored. Exemplarily, the corresponding switch states of the light-emitting devices when required to exhibit the lighting effect including the characters “Baby in Car” may be stored; and the corresponding switch states of the light-emitting devices when required to the lighting effect including the pattern of the stick figure of the pregnant woman may also be stored.

In the case where the corresponding relationships between the different lighting effects and the switch states of the light-emitting devices outside the vehicle are pre-stored, the target switch states of the light-emitting devices corresponding to the target lighting effects to be exhibited may be determined based on the corresponding relationships and the target lighting effects determined in step 2031.

Step 2033: Generating the first prompt information for indicating that the light-emitting devices conform to the target switch states.

The switch states of the light-emitting devices outside the vehicle may be controlled to conform to the target switch states by the first prompt information, so that the light-emitting devices exhibit the target lighting effects, so as to achieve the purpose of prompting the presence of the target object in the vehicle by the target lighting effects.

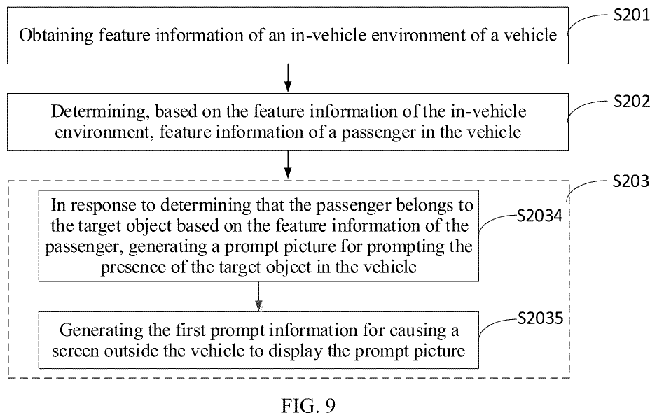

In another possible embodiment of this disclosure, as shown in FIG. 9, step 203 may include the following steps on the basis of the above embodiment shown in FIG. 2.

Step 2034: In response to determining that the passenger belongs to the target object based on the feature information of the passenger, generating a prompt picture for prompting the presence of the target object in the vehicle.

Exemplarily, if the target object is the pregnant woman, the prompt picture may be a picture including the pregnant woman, and text “Pregnant Woman in Vehicle, Please Give Us Your Support and Consideration” may be displayed on the picture; and if the target object is the infant, the prompt picture may be a picture including the infant, and text “Baby in Vehicle, Please Give Us Your Support and Consideration” may be displayed on the picture.

Of course, the prompt picture may also be pictures in other forms, which is not limited this disclosure.

Step 2035: Generating the first prompt information for causing a screen outside the vehicle to display the prompt picture.

The screen outside the vehicle may be caused to display the prompt picture by the first prompt information, so as to achieve the purpose of prompting the presence of the target object in the vehicle by the prompt picture.

In the above embodiment, a way is provided, in response to determining that the passenger belongs to the target object based on the feature information of the passenger, to generate the first prompt information for prompting the presence of the target object in the vehicle. In order to achieve a prompt that the driver is in the target driving state, in the embodiment of this disclosure, the second prompt information for indicating that the driver is in the target driving state may also be generated.

In one possible embodiment of this disclosure, the operation of in response to determining a driving state of the driver being a target driving state based on the driving behavior information, generating second prompt information for prompting that the driver is in the target driving state may be achieved by the following steps.

Firstly, the driving state of the driver is determined being the target driving state based on the driving behavior information, and an intended lighting effect for prompting that the driver is in the target driving state is determined, wherein the intended lighting effect may be characters for prompting that the driving state of the driver is the target driving state. Exemplarily, if the target driving state is a novice state, the intended lighting effect may include the characters “I Am a Novice, Please Give Me Your Support and Consideration”. Of course, the intended lighting effect may also be lighting effects in other forms, which is not limited this disclosure.

Then, the corresponding switch states of light-emitting devices corresponding to the intended lighting effect to be exhibited is determined based on pre-stored corresponding relationships between different lighting effects and switch states of the light-emitting devices outside the vehicle. Exemplarily, the corresponding switch states of the light-emitting devices required for exhibiting the lighting effect including the characters “I Am a Novice, Please Give Me Your Support and Consideration” may be stored. After determining the respective switch states of the light-emitting devices corresponding to the intended lighting effects to be exhibited, the second prompt information for indicating that the light-emitting devices conform to the corresponding switch states is generated.

The switch states of the light-emitting devices outside the vehicle may be controlled to conform to the corresponding switch states by the second prompt information generated in this implementation, so that the light-emitting devices exhibit the intended lighting effects, so as to achieve a prompt that the driving state of the driver is the target driving state by the intended lighting effect.

In another possible embodiment of this disclosure, the operation of in response to determining a driving state of the driver being a target driving state based on the driving behavior information, generating second prompt information for prompting that the driver is in the target driving state may be achieved by the following steps.

Firstly, the driving state of the driver is determined being the target driving state based on the driving behavior information, and a prompt picture for prompting that the driver is in the target driving state is generated. Exemplarily, if the target driving state is a novice state, the prompt picture may be a picture including the driver driving the vehicle, and the characters “I Am a Novice, Please Give Me Your Support and Consideration” are displayed around the driver in the picture. Of course, the prompt picture may also be pictures in other forms, which is not limited this disclosure.

Then, the second prompt information for causing a screen outside the vehicle to display the prompt picture for prompting that the driver is in the target driving state is generated. The screen outside the vehicle may be caused to display the prompt picture by the second prompt information, so as to prompt that the driver is in the target driving state by the prompt picture.

### Exemplary Apparatus

The following is an apparatus embodiment of this disclosure, which may be used for executing the method embodiment of this disclosure. For details not disclosed in the apparatus embodiment of this disclosure, reference may be made to the method embodiment of this disclosure.

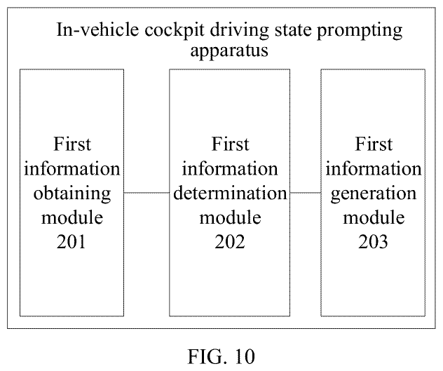

FIG. 10 is a diagram of a structure of an in-vehicle cockpit driving state prompting apparatus provided by an exemplary embodiment of this disclosure. The apparatus may include: a first information obtaining module 201, a first information determination module 202 and a first information generation module 203.

The first information obtaining module 201 is configured for obtaining feature information of an in-vehicle environment of a vehicle;

the first information determination module 202 is configured for determining, based on the feature information of the in-vehicle environment obtained by the first information obtaining module 201, feature information of a passenger in the vehicle; and the first information generation module 203 is configured for, in response to determining that the passenger belongs to a target object based on the feature information of the passenger determined by the first information determination module 202, generating first prompt information for prompting the presence of the target object in the vehicle.

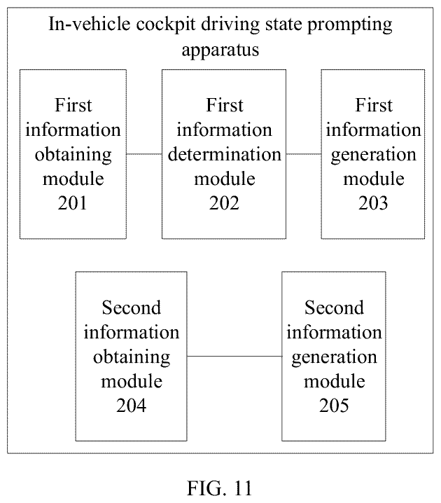

Further, referring to a schematic structural diagram shown in FIG. 11, the in-vehicle cockpit driving state prompting apparatus disclosed in another embodiment of this disclosure further includes: a second information obtaining module 204 and a second information generation module 205.

The second information obtaining module 204 is configured for obtaining driving behavior information of a driver in a first driving scenario; and the second information generation module 205 is configured for, in response to determining a driving state of the driver being a target driving state based on the driving behavior information obtained by the second information obtaining module 204, generating second prompt information for prompting that the driver is in the target driving state, so as to display the second prompt information by the vehicle.

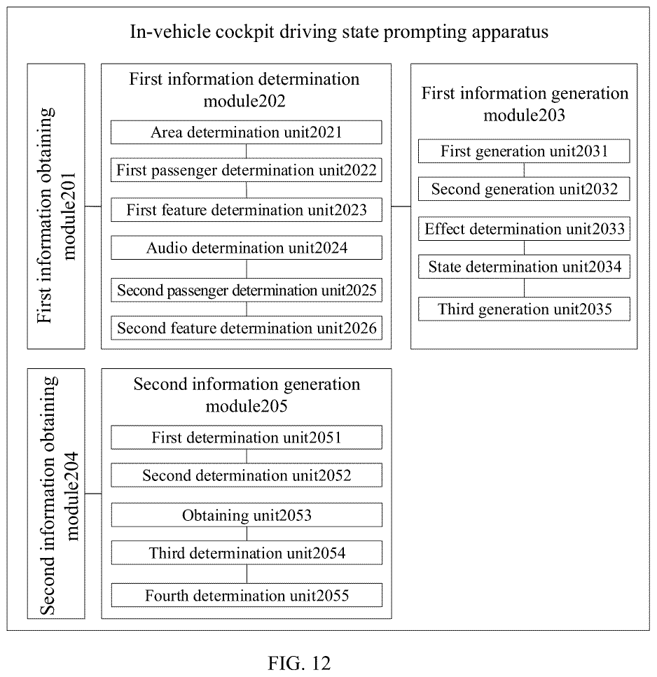

In one possible implementation, referring to FIG. 12, the second information generation module 205 includes: a first determination unit 2051 and a second determination unit 2052.

The first determination unit 2051 is configured for determining the number of times that the driver executes contradictory operations within a first preset duration and an interval duration between two adjacent contradictory operations based on the driving behavior information; and the second determination unit 2052 is configured for determining the driving state of the driver being the target driving state in response to the number of times determined by the first determination unit 2051 being greater than or equal to a first preset threshold and the interval duration determined by the first determination unit 2051 being less than or equal to a second preset threshold.

In another possible implementation, the second information generation module 205 includes: an obtaining unit 2053, a third determination unit 2054 and a fourth determination unit 2055.

The obtaining unit 2053 is configured for obtaining a driving instruction generated for the first driving scenario;

the third determination unit 2054 is configured for determining a first operation executed by the vehicle indicated by the driving behavior information and a second operation executed by the vehicle indicated by the driving instruction obtained by the obtaining unit 2053; and the fourth determination unit 2055 is configured for determining the driving state of the driver being the target driving state in response to the first operation and the second operation determined by the third determination unit 2054 being contradictory operations and a time interval between an obtaining moment of the driving instruction and an obtaining moment of the driving behavior information being within a second preset duration.

In another embodiment of this disclosure, the first information generation module 203 includes: a first generation unit 2031 and a second generation unit 2032.

The first generation unit 2031 is configured for determining that the gender corresponding to the passenger is female based on the gender in the feature information of the passenger, and determining that the passenger is a pregnant woman based on the posture information in the feature information of the passenger, and then generating first sub-prompt information for prompting the presence of the pregnant woman in the vehicle; and the second generation unit 2032 is configured for determining that the passenger is an infant based on the age in the feature information of the passenger, and then generating second sub-prompt information for prompting the presence of the infant in the vehicle.

In another embodiment of this disclosure, the feature information of the in-vehicle environment includes an image of the in-vehicle environment, and the first information determination module 202 includes: an area determination unit 2021, a first passenger determination unit 2022 and a first feature determination unit 2023.

The area determination unit 2021 is configured for determining, based on the image of the in-vehicle environment, that the image includes at least one area of a facial feature;
the first passenger determination unit 2022 is configured for determining, based on the area determined by the area determination unit 2021, that a person corresponding to the area is the passenger; and
the first feature determination unit 2023 is configured for determining, based on an image corresponding to the area determined by the area determination unit 2021, the feature information of the passenger determined by the first passenger determination unit 2022.

In another embodiment of this disclosure, the feature information of the in-vehicle environment includes audio information of the in-vehicle environment, and the first information determination module 202 includes: an audio determination unit 2024, a second passenger determination unit 2025 and a second feature determination unit 2026.

The audio determination unit 2024 is configured for determining a position of a sound source and an audio feature of the audio information of the in-vehicle environment;
the second passenger determination unit 2025 is configured for determining, based on the position of the sound source of the audio information determined by the audio determination unit 2024, the position of the sound source being the position of the passenger; and
the second feature determination unit 2026 is configured for determining, based on identification of the audio feature determined by the audio determination unit 2024, the feature information of the passenger.

In another embodiment of this disclosure, the first information generation module 203 may include: an effect determination unit 2033, a state determination unit 2034 and a third generation unit 2035.

The effect determination unit 2033 is configured for, in response to determining that the passenger belongs to the target object based on the feature information of the passenger, determining a target lighting effect for prompting the presence of the target object in the vehicle;
the state determination unit 2034 is configured for determining, based on pre-stored corresponding relationships between different lighting effects and switch states of the light-emitting devices outside the vehicle, the target switch states of light-emitting devices corresponding to to-be-exhibited target lighting effects determined by the effect determination unit 2033; and
the third generation unit 2035 is configured for generating the first prompt information for indicating that the light-emitting devices conform to the target switch states determined by the state determination unit 2034.

In another embodiment of this disclosure, the first information generation module may include: a picture generation unit and a fourth generation unit.

The picture generation unit is configured for, in response to determining that the passenger belongs to the target object based on the feature information of the passenger, generating a prompt picture for prompting the presence of the target object in the vehicle; and
the fourth generation unit is configured for generating the first prompt information for causing a screen outside the vehicle to display the prompt picture.

The apparatus provided by the embodiment of this disclosure can prompt the cockpit driving state of the presence of the target object in the vehicle by the first prompt information. Moreover, this solution does not require manual participation of a user, and therefore has simpler implementations compared with the existing solution of affixing the sticker. Moreover, since the first prompt information is generated according to the feature information of the in-vehicle environment of the vehicle, if the feature information of the in-vehicle environment of the vehicle changes, the vehicle generates the first prompt information according to the changed feature information, and therefore the first prompt information can reflect the change in the in-vehicle cockpit driving state. Accordingly, the solution of this disclosure has the advantage of better timeliness.

### Exemplary Electronic Device

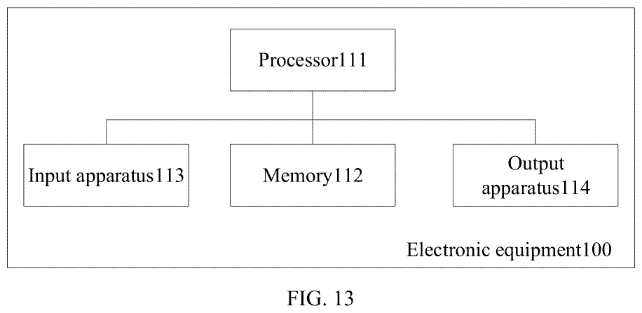

FIG. 13 is a structural diagram of electronic device provided by an embodiment of this disclosure, including at least one second processor 111 and a memory 112.

The second processor 111 may be a central processing unit (CPU) or processing units in other forms having data processing capabilities and/or instruction execution capabilities, and may control other components in the electronic device 100 to execute desired functions.

The memory 112 may include one or more computer program products which may include computer-readable storage media in various forms, such as a volatile memory and/or a non-volatile memory. The volatile memory may include, for example, a random access memory (RAM) and/or a cache, and the like. The non-volatile memory may include, for example, a read-only memory (ROM), a hard disk, a flash memory, and the like. One or more computer program instructions may be stored on the computer readable storage medium, and the second processor 111 may run the one or more computer program instructions to implement the in-vehicle cockpit driving state prompting method in various Embodiments of this disclosure above and/or other desired functions.

In one instance, the electronic device 100 may further include: an input apparatus 113 and an output apparatus 114, and these components are interconnected through a bus system and/or connection mechanisms in other forms (not shown).

The input apparatus 113 may further include, for example, a keyboard, a mouse, and the like. Exemplarily, the input apparatus 113 may include a sensor. The sensor may include a sensor for collecting feature information of an in-vehicle environment, such as an in-vehicle image collection apparatus and/or audio collection apparatus. Moreover, the sensor may further include a sensor for collecting feature information of an out-of-vehicle environment and the in-vehicle environment, such as at least one of an out-of-vehicle image collection apparatus, radar (such as lidar) and an ultrasonic sensor.

The output apparatus 114 may output various information to the outside which may include, for example, a display, a speaker, a printer, as well as a communication network and remote output equipment connected to the communication network, and the like. Exemplarily, the output apparatus 114 may include a light-emitting device disposed outside the vehicle, and the light-emitting device may display a light effect corresponding to the first prompt information and/or the second prompt information. Or the output apparatus 114 may include a screen disposed outside the vehicle, and the screen may display a picture corresponding to the first prompt information and/or the second prompt information.

Of course, for simplicity, only some of the components in the electronic device 100 relevant to this disclosure are shown in FIG. 13, and the components such as buses, input/output interfaces, and the like, are omitted. In addition, the electronic device 100 may further include any other suitable components according to specific application situations.

### Exemplary Computer Program Product and Computer-Readable Storage Medium

In addition to the method and equipment described above, an embodiment of this disclosure may further provide a computer program product, including a computer program instruction which, when run by a processor, causes the processor to execute the steps in the in-vehicle cockpit driving state prompting method in various Embodiments of this disclosure described in the “exemplary method” section above.

The computer program product may write program codes for executing operation of the embodiment of this disclosure in one or any combination of more programming languages, and the programming languages include object-oriented programming languages, such as Java and C++, and further include conventional procedural programming languages, such as “C” language or similar programming languages. The program codes may be executed entirely on computing equipment of the user, executed partially on the computing equipment of the user, executed as a stand-alone software package, executed partially on the computing equipment of the user and partially on remote computing equipment, or executed entirely on the remote computing equipment or a server.

In addition, an embodiment of this disclosure may also be a computer-readable storage medium having stored thereon a computer program instruction which, when run by a processor, causes the processor to execute the steps in the in-vehicle cockpit driving state prompting method in various Embodiments of this disclosure described in the “exemplary method” section above.

One or any combination of more readable media may be adopted as the computer-readable storage medium. The readable medium may be a readable signal medium or a readable storage medium. The readable storage medium includes, but is not limited to, for example, electrical, magnetic, optical, electromagnetic, infrared or semiconductor systems, apparatuses or devices, or any combination thereof. More specific instances (a non-exhaustive list) of the readable storage medium include: electrical connection having one or more lead wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

While the general principles of this disclosure have been described above in conjunction with specific Embodiments, the benefits, advantages, effects, and the like mentioned this disclosure are merely exemplary and not limiting, and are not to be construed as necessarily required by various Embodiments of this disclosure. In addition, the specific details disclosed above are for the purposes of illustration and convenience in understanding only and are not intended to be limiting, and the above details are not intended to limit this disclosure to be implemented by necessarily adopting the above specific details.

Various modifications and variations of this disclosure may be made by those skilled in the art without departing from the spirit and scope of the present application. Thus, it is intended that this disclosure covers these modifications and variations provided that these modifications and variations of the present application fall within the scope of the claims and equivalents thereof this disclosure.

What is claimed is:

1. An in-vehicle cockpit driving state prompting method, comprising:
obtaining feature information of an in-vehicle environment of a vehicle;
determining, based on the feature information of the in-vehicle environment, feature information of a passenger in the vehicle; and
in response to determining that the passenger belongs to a target object based on the feature information of the passenger, generating first prompt information for prompting the presence of the target object in the vehicle, so as to display the first prompt information by the vehicle.

2. The method according to claim 1, further comprising:
obtaining driving behavior information of a driver in a first driving scenario; and
in response to determining a driving state of the driver being a target driving state based on the driving behavior information, generating second prompt information for prompting that the driver is in the target driving state, so as to display the second prompt information by the vehicle.

3. The method according to claim 2, wherein the in response to determining a driving state of the driver being a target driving state based on the driving behavior information, comprises:
determining, based on the driving behavior information, the number of times that the driver executes contradictory operations within a first preset duration and an interval duration between two adjacent contradictory operations; and
in response to the number of times being greater than or equal to a first preset threshold and the interval duration being less than or equal to a second preset threshold, determining the driving state of the driver being the target driving state,
wherein the driving behavior information reflects operations executed by the driver, which comprise accelerating operation, decelerating operation, braking operation, straight-line operation, left-turn operation, right-turn operation, and wherein the contradictory operations of the accelerating operation comprise the decelerating operation and the braking operation, the contradictory operation of the decelerating operation comprise the accelerating operation, the contradictory operation of the braking operation comprise the accelerating operation, the contradictory operations of the straight-line operation comprise the left-turn operation and the right-turn operation, the contradictory operations of the left-turn operation comprise the straight-line operation and the right-turn operation, and the contradictory operations of the right-turn operation comprise the straight-line operation and the left-turn operation.

4. The method according to claim 2, wherein the in response to determining a driving state of the driver being a target driving state based on the driving behavior information, comprises:
obtaining a driving instruction generated for the first driving scenario;
determining a first operation executed by the vehicle indicated by the driving behavior information and a second operation executed by the vehicle indicated by the driving instruction; and
determining the driving state of the driver being the target driving state in response to the first operation and the second operation being contradictory operations and a time interval between an obtaining moment of the driving instruction and an obtaining moment of the driving behavior information being within a second preset duration,
wherein the driving behavior information reflects operations executed by the driver, which comprise accelerating operation, decelerating operation, braking operation, straight-line operation, left-turn operation, right-turn operation, and wherein the contradictory operations of the accelerating operation comprise the decelerating operation and the braking operation, the contradictory operation of the decelerating operation comprise the accelerating operation, the contradictory operation of the braking operation comprise the accelerating operation, the contradictory operations of the straight-line operation comprise the left-turn operation and the right-turn operation, the contradictory operations of the left-turn operation comprise the straight-line operation and the right-turn operation, and the contradictory operations of the right-turn operation comprise the straight-line operation and the left-turn operation.

5. The method according to claim 1, wherein the feature information of the in-vehicle environment comprises an image of the in-vehicle environment, and the determining, based on the feature information of the in-vehicle environment, feature information of a passenger in the vehicle, comprises:
determining, based on the image of the in-vehicle environment, that the image comprises at least one area of a facial feature;
determining, based on the at least one area of a facial feature, that a person corresponding to the at least one area of a facial feature is the passenger; and
determining, based on an image corresponding to the at least one area of a facial feature, the feature information of the passenger.

6. The method according to claim 1, wherein the feature information of the in-vehicle environment comprises audio information of the in-vehicle environment, and the determining, based on the feature information of the in-vehicle environment, feature information of a passenger in the vehicle, comprises:
determining a position of a sound source and an audio feature of the audio information of the in-vehicle environment;
determining, based on the position of the sound source of the audio information, the position of the sound source being the position of the passenger; and
determining, based on identification of the audio feature, the feature information of the passenger.

7. The method according to claim 1, wherein the in response to determining that the passenger belongs to a target object based on the feature information of the passenger, generating first prompt information for prompting the presence of the target object in the vehicle, comprises:
In response to determining that the passenger belongs to the target object based on the feature information of the passenger, determining a target lighting effect for prompting the presence of the target object in the vehicle;
determining, based on pre-stored corresponding relationships between different lighting effects and switch states of the light-emitting devices outside the vehicle, the target switch states of light-emitting devices corresponding to the target lighting effect to be exhibited; and
generating the first prompt information for indicating that the light-emitting devices conform to the target switch states.

8. The method according to claim 1, wherein the in response to determining that the passenger belongs to a target object based on the feature information of the passenger, generating first prompt information for prompting the presence of the target object in the vehicle, comprises:
in response to determining that the passenger belongs to the target object based on the feature information of the passenger, generating a prompt picture for prompting the presence of the target object in the vehicle; and
generating the first prompt information for causing a screen outside the vehicle to display the prompt picture.

9. The method according to claim 1, wherein the feature information of the passenger comprises at least one of gender, age and posture information.

10. An electronic device, comprising:
a processor; and
a memory configured for storing processor-executable instructions;
wherein the processor is configured for reading the executable instructions from the memory and executing the instructions to implement an in-vehicle cockpit driving state prompting method,
wherein the method comprises:
obtaining feature information of an in-vehicle environment of a vehicle;
determining, based on the feature information of the in-vehicle environment, feature information of a passenger in the vehicle; and
in response to determining that the passenger belongs to a target object, generating first prompt information for prompting the presence of the target object in the vehicle, so as to display the first prompt information by the vehicle.

11. The electronic device according to claim 10, wherein the method further comprises:
obtaining driving behavior information of a driver in a first driving scenario; and
in response to determining a driving state of the driver being a target driving state based on the driving behavior information, generating second prompt information for prompting that the driver is in the target driving state, so as to display the second prompt information by the vehicle.

12. The electronic device according to claim 11, wherein the in response to determining a driving state of the driver being a target driving state based on the driving behavior information, comprises:
determining, based on the driving behavior information, the number of times that the driver executes contradictory operations within a first preset duration and an interval duration between two adjacent contradictory operations; and
in response to the number of times being greater than or equal to a first preset threshold and the interval duration being less than or equal to a second preset threshold, determining the driving state of the driver being the target driving state,
wherein the driving behavior information reflects operations executed by the driver, which comprise accelerating operation, decelerating operation, braking operation, straight-line operation, left-turn operation, right-turn operation, and wherein the contradictory operations of the accelerating operation comprise the decelerating operation and the braking operation, the contradictory operation of the decelerating operation comprise the accelerating operation, the contradictory operation of the braking operation comprise the accelerating operation, the contradictory operations of the straight-line operation comprise the left-turn operation and the right-turn operation, the contradictory operations of the left-turn operation comprise the straight-line operation and the right-turn operation, and the contradictory operations of the right-turn operation comprise the straight-line operation and the left-turn operation.

13. The electronic device according to claim 11, wherein the in response to determining a driving state of the driver being a target driving state based on the driving behavior information, comprises:
obtaining a driving instruction generated for the first driving scenario;
determining a first operation executed by the vehicle indicated by the driving behavior information and a second operation executed by the vehicle indicated by the driving instruction; and
determining the driving state of the driver being the target driving state in response to the first operation and the second operation being contradictory operations and a time interval between an obtaining moment of the driving instruction and an obtaining moment of the driving behavior information being within a second preset duration,
wherein the driving behavior information reflects operations executed by the driver, which comprise accelerating operation, decelerating operation, braking operation, straight-line operation, left-turn operation, right-turn operation, and wherein the contradictory operations of the accelerating operation comprise the decelerating operation and the braking operation, the contradictory operation of the decelerating operation comprise the accelerating operation, the contradictory operation of the braking operation comprise the accelerating operation, the contradictory operations of the straight-line operation comprise the left-turn operation and the right-turn operation, the contradictory operations of the left-turn operation comprise the straight-line operation and the right-turn operation, and the contradictory operations of the right-turn operation comprise the straight-line operation and the left-turn operation.

14. The electronic device according to claim 10, wherein the feature information of the in-vehicle environment comprises an image of the in-vehicle environment, and the determining, based on the feature information of the in-vehicle environment, feature information of a passenger in the vehicle, comprises:
determining, based on the image of the in-vehicle environment, that the image comprises at least one area of a facial feature;
determining, based on the at least one area of a facial feature, that a person corresponding to the at least one area of a facial feature is the passenger; and
determining, based on an image corresponding to the at least one area of a facial feature, the feature information of the passenger.

15. The electronic device according to claim 10, wherein the feature information of the in-vehicle environment comprises audio information of the in-vehicle environment, and the determining, based on the feature information of the in-vehicle environment, feature information of a passenger in the vehicle, comprises:
determining a position of a sound source and an audio feature of the audio information of the in-vehicle environment;
determining, based on the position of the sound source of the audio information, the position of the sound source being the position of the passenger; and
determining, based on identification of the audio feature, the feature information of the passenger.

16. The electronic device according to claim 10, wherein the in response to determining that the passenger belongs to a target object based on the feature information of the passenger, generating first prompt information for prompting the presence of the target object in the vehicle, comprises:
In response to determining that the passenger belongs to the target object based on the feature information of the passenger, determining a target lighting effect for prompting the presence of the target object in the vehicle;
determining, based on pre-stored corresponding relationships between different lighting effects and switch states of the light-emitting devices outside the vehicle, the target switch states of light-emitting devices corresponding to the target lighting effect to be exhibited; and
generating the first prompt information for indicating that the light-emitting devices conform to the target switch states.

17. The electronic device according to claim 10, wherein the in response to determining that the passenger belongs to a target object based on the feature information of the passenger, generating first prompt information for prompting the presence of the target object in the vehicle, comprises:
in response to determining that the passenger belongs to the target object based on the feature information of the passenger, generating a prompt picture for prompting the presence of the target object in the vehicle; and
generating the first prompt information for causing a screen outside the vehicle to display the prompt picture.

18. The electronic device according to claim 10, wherein the processor is a central processing unit or processing units in other forms having data processing capabilities and/or instruction execution capabilities.

19. The electronic device according to claim 10, wherein the electronic device further comprises: an input apparatus and an output apparatus, and these components are interconnected through a bus system and/or connection mechanisms in other forms.

20. A non-transitory computer-readable storage medium, wherein the storage medium stores a computer program for executing an in-vehicle cockpit driving state prompting method, wherein the method comprises:
obtaining feature information of an in-vehicle environment of a vehicle;
determining, based on the feature information of the in-vehicle environment, feature information of a passenger in the vehicle; and
in response to determining that the passenger belongs to a target object based on the feature information of the passenger, generating first prompt information for prompting the presence of the target object in the vehicle, so as to display the first prompt information by the vehicle.
